(19) United States
(12) Patent Application Publication
(10) Pub. No.: US 2007/0025555 A1
(43) Pub. Date: Feb. 1, 2007

(54) Method and apparatus for processing information, and computer product

(75) Inventors: Nobuyuki Gonai, Kawasaki (JP); Satoshi Mikami, Kawasaki (JP); Sumio Koseki, Kawasaki (JP); Masayoshi Sueya, Kawasaki (JP); Masaru Nagahama, Kawasaki (JP); Junya Mikami, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/252,741

(22) Filed: Oct. 19, 2005

(30) Foreign Application Priority Data
Jul. 28, 2005 (JP) 2005-218693

(51) Int. Cl. H04R 5/00

(52) U.S. Cl. 381/17

(57) ABSTRACT

A sound-signal generating unit generates, when a positional relationship between a local information processing apparatus and a user is acquired, a sound signal that makes the user perceive a virtual sound source at a predetermined position in a three-dimensional space based on the acquired positional relationship.

### BACKGROUND OF THE INVENTION

1. Field of the Invention

The present invention relates to a technology for reproducing 3D surround sound effect in an information processing apparatus, such as a cell phone.

2. Description of the Related Art

Recently, a trend in a cell phone is mounting stereo speakers to download a music file from a music-distribution server via a network, and to reproduce the music in stereo. Another trend in the cell phone is a television-phone function that provides not only a voice communication but also an image of the other party of a call.

Because the call sound of the television-phone is provided in monaural, the television-phone is not able to reproduce a realistic sound like reproducing a music file in stereo.

A technology to reproduce a sound that is recorded using a plurality of microphones mounted in a cell phone of the other party by using a plurality of speakers mounted in a local cell phone is disclosed in, for example, Japanese Patent Application Laid-open No. 2004-56408.

In addition, recent cell phones include a 3D surround function. The 3D surround function is a technology for reproducing a three-dimensional (3D) stereoscopic sound field. With the 3D surround function, it is possible to reproduce a fully realistic sound field with virtual sound sources above, below, left, and right of a listener.

However, because the conventional 3D surround function described above reproduces the sound field based on an assumption that a distance between a cell phone and a user is constant, the effect of the 3D surround function becomes ineffective when the distance changes.

FIG. 13 is a schematic for illustrating the conventional 3D surround function. In a conventional cell phone, it is assumed that the distance to the user is fixed, based on which, the cell phone generates a sound that is audible in the right direction and a sound that is audible in the left direction, to make the user perceive that a virtual sound source is at a predetermined position, and outputs the sounds from left and right speakers.

The distance between the cell phone and the user is determined by a distance that is obtained statistically from a distance between the cell phone and the face of the user when using the cell phone.

However, as shown in FIG. 13, if the user moves back and forth, a relative position of the virtual sound source to the user deviates and the effect of the 3D surround function cannot be obtained.

Consequently, there remains an important issue of developing a technology that can obtain an adequate effect of the 3D surround function even when the relative position of the cell phone to the user changes.

### SUMMARY OF THE INVENTION

It is an object of the present invention to at least solve the problems in the conventional technology.

An information processing apparatus according to one aspect of the present invention includes a sound-signal generating unit that generates, when a positional relationship between a local information processing apparatus and a user is acquired, a sound signal that makes the user perceive a virtual sound source at a predetermined position in a three-dimensional space based on the acquired positional relationship.

An information processing method according to another aspect of the present invention includes acquiring a positional relationship between a local information processing apparatus and a user; and generating a sound signal that makes the user perceive a virtual sound source at a predetermined position in a three-dimensional space based on the acquired positional relationship.

A computer-readable recording medium according to still another aspect of the present invention stores a computer program therein. The computer program causes a computer to execute acquiring a positional relationship between a local information processing apparatus and a user; storing information on the positional relationship; and generating a sound signal that makes the user perceive a virtual sound source at a predetermined position in a three-dimensional space based on the information stored at the storing.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for illustrating a concept of a sound-signal generating process according to the present invention;

FIG. 2 is a schematic for illustrating a position detecting process for detecting a position of a user in a vertical direction;

FIG. 3 is a block diagram of a cell phone according to an embodiment of the present invention;

FIG. 4 is a schematic for illustrating a plurality of speakers mounted on the cell phone according to the present embodiment;

FIG. 5 is a schematic of an adjustment mechanism that extends a left speaker and a right speaker;

FIG. 6 is a schematic of an example of a display screen for displaying sound field/sound pressure setting information;

FIG. 7 is a flowchart of processing procedure for a sound-signal generating process according to the present embodiment;

FIG. 8 is a schematic for illustrating a user detecting window that limits a detection range of a user;

FIG. 9 is a schematic for illustrating a process to detect a positional relationship between a cell phone and a user by irradiating two directional beams;

FIG. 10 is a schematic for illustrating a process to detect the positional relationship between the cell phone and the user from distances measured by two distance measuring units;

FIG. 11 is a schematic for illustrating a process to transmit a sound signal for 3D surround to other cell phones;

FIG. 12 is a block diagram of a hardware configuration of a computer that implements the cell phone shown in FIG. 3; and

FIG. 13 is a schematic for illustrating a conventional 3D surround function.

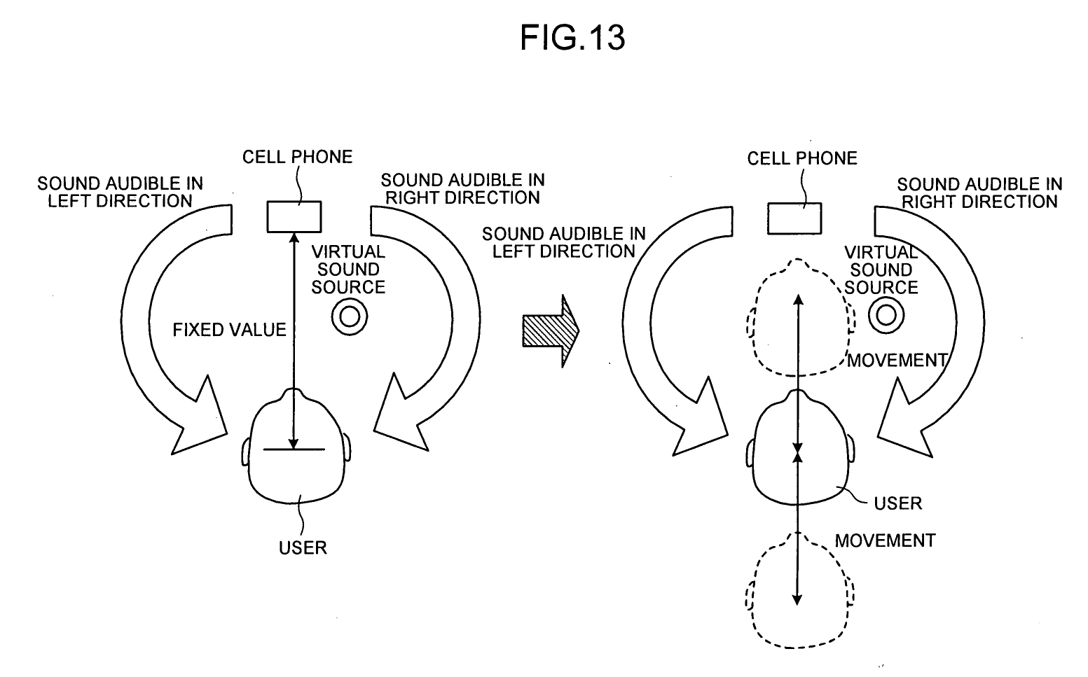

### DETAILED DESCRIPTION OF THE PREFERRED EMBODIMENTS

Exemplary embodiments of the present invention will be explained in detail with reference to the accompanying drawings. An explanation will be given for a cell phone including an imaging device as an example of an information processing apparatus according to the present invention.

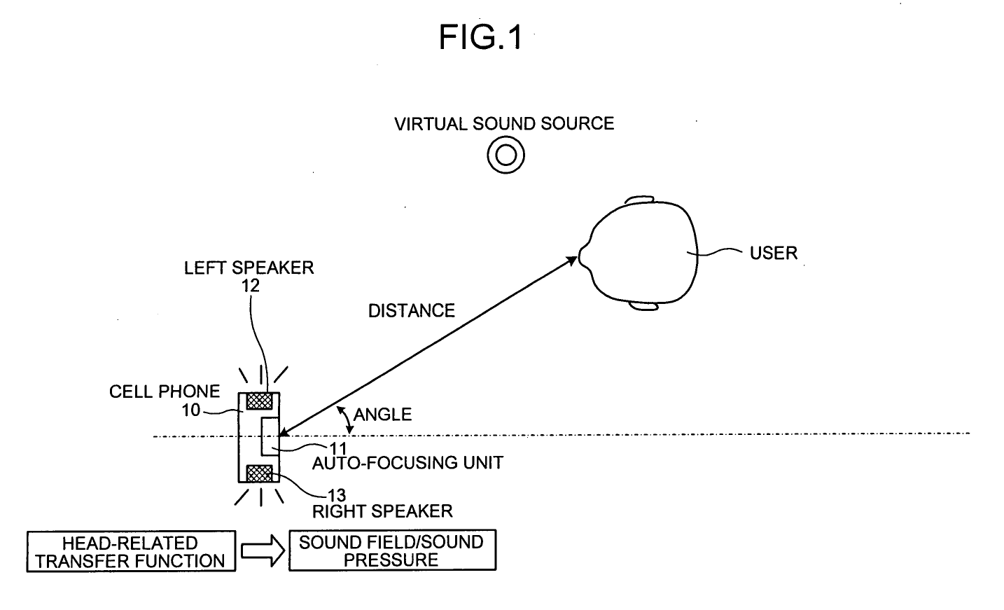

FIG. 1 is a schematic for illustrating a concept of a sound-signal generating process according to the present invention. A cell phone 10 that performs a sound-signal generating process includes an auto-focusing unit 11 that automatically focuses the imaging device on an object.

The auto-focusing unit 11 measures a distance to the object. The auto-focusing unit 11 is movable and can change its orientation in a direction of the object. An angle between the direction of the object and a front direction of the cell phone 10 is measured from an angle formed by changing the orientation of the auto-focusing unit 11.

In the sound-signal generating process, a sound signal for 3D surround that makes a user perceive that there is a sound source at a predetermined position is generated, based on a positional relationship between the user and the cell phone 10.

A distance between the user and the cell phone 10, and an angle between the front direction of the cell phone 10 and the direction of the user are measured, and a position of a virtual sound source to be perceived by the user is corrected by using the measure distance and angle.

Furthermore, in the sound-signal generating process, sound field and acoustic pressure that make the user perceive that the sound source is at a corrected position are generated by using uses information on the corrected position of the sound source and a head-related transfer function.

From the information on the corrected sound source position and the head-related transfer function, a sound signal that is output from a left speaker 12 and a right speaker 13 of the cell phone 10 is generated.

Although the auto-focusing unit 11 detects a position of the user in a horizontal direction in an example shown in FIG. 1, it can also detect the position of the user in a vertical direction.

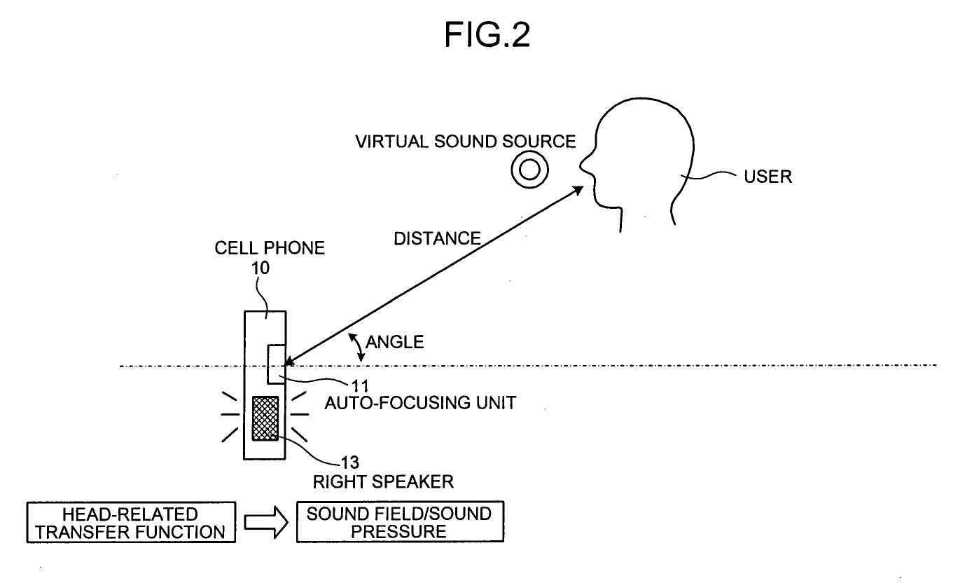

FIG. 2 is a schematic for illustrating a position detecting process for detecting a position of a user in a vertical direction. The orientation of the auto-focusing unit 11 changes in the vertical direction instead in the horizontal direction.

The positional relationship between a direction to the face of the user and the front direction of the cell phone 10 is detected from the angle formed by changing the orientation of the auto-focusing unit 11 in the vertical direction. Information on the detected angle is used in correcting the position of the virtual sound source that will be perceived by the user like the case shown in FIG. 1.

By executing the sound-signal generating process, the cell phone 10 can adequately realize the effect of the 3D surround function, even when the relative position of the cell phone 10 to the user changes.

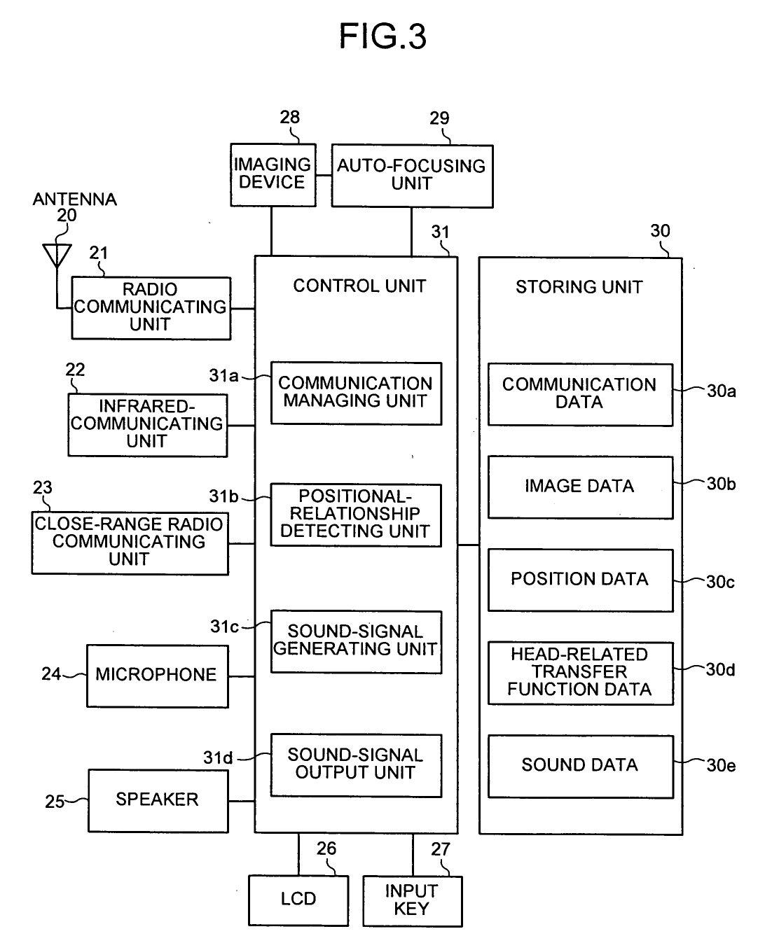

FIG. 3 is a block diagram of the cell phone 10 according to an embodiment of the present invention. The cell phone 10 includes an antenna 20, a radio communicating unit 21, an infrared-communicating unit 22, a close-range radio-communicating unit 23, a microphone 24, a speaker 25, a liquid crystal display (LCD) 26, an input key 27, an imaging device 28, an auto-focusing unit 29, a storing unit 30, and a control unit 31.

The antenna 20 is for transmitting and receiving radio waves. The radio communicating unit 21 connects to other cell phones via a base station of the cell phone 10, and processes sound communications and data communications.

The infrared-communicating unit 22 performs data communication with the other cell phones by transmitting and receiving infrared rays. The close-range radio-communicating unit 23 performs data communication with the other cell phones by close-range radio communications using the Bluetooth standard.

The microphone 24 acquires sound information and converts it into an electrical signal. The speaker 25 outputs phone-call sound and reproduced sound. A plurality of speakers 25 is mounted on the cell phone 10.

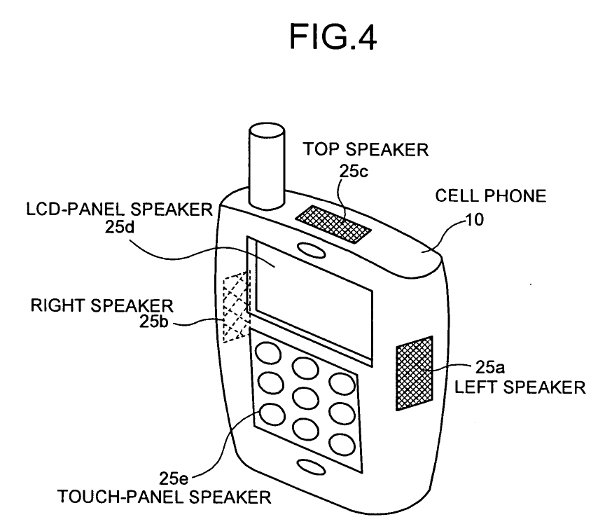

FIG. 4 is a schematic for illustrating a plurality of speakers 25 mounted on the cell phone 10. A left speaker 25a and a right speaker 25b are respectively provided on left and right sides of the cell phone 10.

A top speaker 25c can be mounted on a top surface of the cell phone 10 spatially between the left speaker 25a and the right speaker 25b. It is also acceptable to provide an LCD-panel speaker 25d and a touch-panel speaker 25e spatially between the left speaker 25a and the right speaker 25b.

The LCD-panel speaker 25d is a display and speaker apparatus that outputs sound onto an LCD panel that can display an image. The touch-panel speaker 25e is a touch panel and speaker apparatus that, when the cell phone 10 includes a touch panel for inputting data instead of the input key 27, outputs sound to the touch panel.

The left speaker 25a and the right speaker 25b can be extended from the cell phone 10. The left speaker 25a and the right speaker 25b are connected to the main unit of the cell phone 10 by a cable that transfers sound signals to the left speaker 25a and the right speaker 25b.

The left speaker 25a and the right speaker 25b can be automatically extended from the cell phone 10. When the positional relationship between the user and the cell phone 10 is detected, the left speaker 25a and the right speaker 25b are adjusted by extending from the cell phone 10 by a predetermined distance to maximize the effect of the 3D surround function.

The speakers 25a to 25e realize a multi-channel 3D surround function by outputting different sound signals. The sound signals output from the speakers 25a to 25e are sound signals for 3D surround function that are adjusted according to the installation positions of the speakers 25a to 25e so that the user can perceive a sound source at a predetermined position.

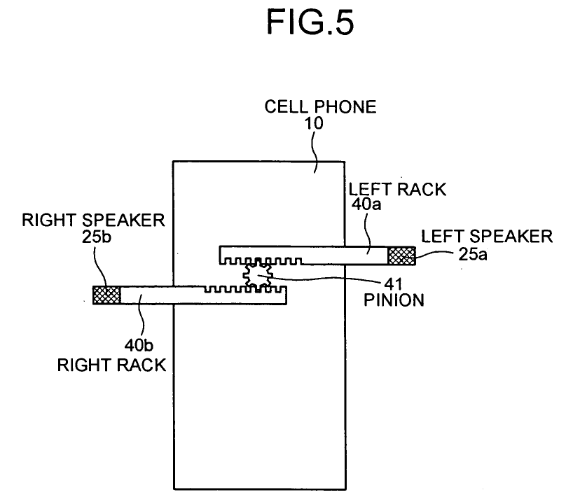

FIG. 5 is a schematic of an adjustment mechanism that extends a left speaker 25a and a right speaker 25b. The adjustment mechanism includes a left rack 40a having the left speaker 25a installed at its tip, a right rack 40b having the right speaker 25b installed at its tip, and a pinion 41 with which the left rack 40a and the right rack 40b are engaged.

When the positional relationship between the user and the cell phone 10 is detected, the pinion 41 is rotated by a predetermined angle to move the left speaker 25a and the right speaker 25b to positions at which the effect of the 3D surround function is maximized.

The LCD 26 displays various pieces of information. The input key 27 is used by the user to input information. The imaging device 28 captures a still image or a moving image.

The auto-focusing unit 29 measures a distance from the imaging device 28 to an object and focuses on the object. The orientation of the auto-focusing unit 29 can be changed in up, down, left, and right directions. The auto-focusing unit 29 measures its own orientation.

When an image of the object is being taken in dark surroundings, the auto-focusing unit 29 focuses on the object after a strobe of a light (not shown) to illuminate the object.

The storing unit 30 is a storage device such as a flash memory. The storing unit 30 stores communication data 30a, image data 30b, position data 30c, head-related transfer function data 30d, and sound data 30e.

The communication data 30a is used for performing a data communication with other apparatus. The image data 30b relates to an image taken by the imaging device 28.

The position data 30c relates to positional information of the user that is measured by the auto-focusing unit 29. Specifically, the position data 30c relates to the distance from the cell phone 10 to the user, and the angle between the front direction of the cell phone 10 and the direction of the user.

The head-related transfer function data 30d relates to the head-related transfer function that is referred to when generating a sound signal for 3D surround function. A head-related transfer function is a function expressing the transfer characteristics of sound that reaches to the ear from a sound source.

A sound signal that makes the user perceive a sound source in a predetermined position is generated by selecting a head-related transfer function according to the position of the sound source and the position of the user, and calculating a convolution of the selected head-related transfer function.

The sound data 30e relates to a sound signal for 3D surround function that is generated according to the position of the user.

The control unit 31 controls the entire function of the cell phone 10, and exchanges data between the function units and so on. The control unit 31 includes a communication managing unit 31a, a positional-relationship detecting unit 31b, a sound-signal generating unit 31c, and a sound-signal output unit 31d.

The communication managing unit 31a executes processing of phone-call sound and data communications. The positional-relationship detecting unit 31b detects the positional relationship between the cell phone 10 and the user.

The positional-relationship detecting unit 31b controls the auto-focusing unit 29, measures the distance between the cell phone 10 and the user, and detects this distance. The positional-relationship detecting unit 31b also detects the angle between the front direction of the cell phone 10 and the direction of the object from the orientation of the auto-focusing unit 29. The positional-relationship detecting unit 31b then stores the detected distance and angle as position data 30c in the storing unit 30.

When the left speaker 25a and the right speaker 25b are configured such that they can be automatically extended from the cell phone 10, the positional-relationship detecting unit 31b controls the rotation angle of the pinion 41 according to the positional relationship between the user and the cell phone 10 by adjusting it such that the left speaker 25a and the right speaker 25b are extracted to a predetermined distance from the cell phone 10.

The sound-signal generating unit 31c generates a sound signal for reproducing a predetermined sound field/sound pressure. Specifically, when the positional-relationship detecting unit 31b detects the positional relationship between the cell phone 10 and the user, the sound-signal generating unit 31c corrects the position of the virtual sound source based on this positional relationship, and generates a sound signal from the information relating to the corrected position of the sound source and the head-related transfer function data 30d stored in the storing unit 30.

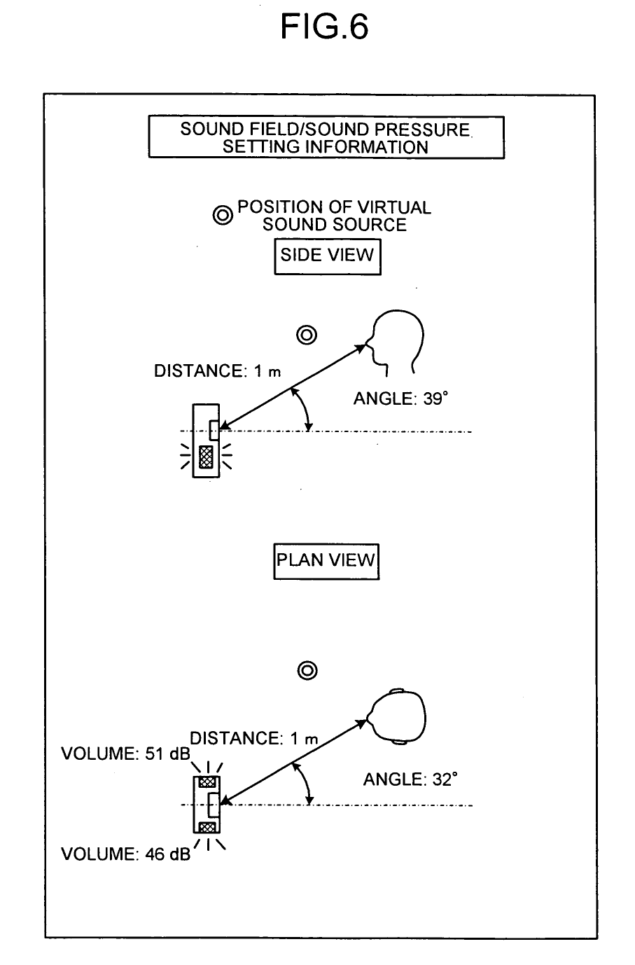

The sound-signal generating unit 31c also displays setting information relating to the sound field/sound pressure on the LCD 26, and reports this to the user. FIG. 6 is a schematic of an example of a display screen for displaying sound field/sound pressure setting information. The display screen displays information relating to the positional relationship between the cell phone 10 and the user (distance and angle), information relating to the sound pressure level of sound output from the speaker 25, information relating to the position of the virtual sound source, and so on.

When there are multiple speakers 25 as shown in FIG. 4, the sound-signal generating unit 31c generates a plurality of different sound signals for 3D surround function to be reproduced in synchronism from the speakers 25, and stores the generated sound signals in the storing unit 30 as sound data 30e.

The sound-signal output unit 31d is an output unit that reads a sound signal for 3D surround function, which is generated by the sound-signal generating unit 31c, from the sound data 30e, and outputs it to the speaker 25.

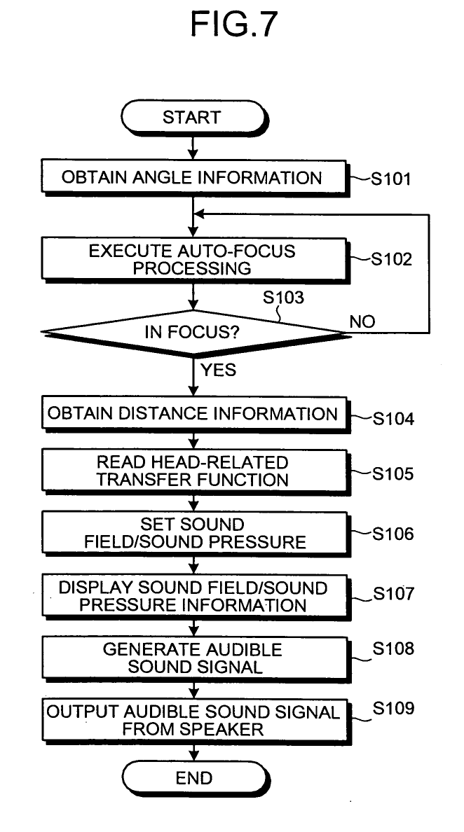

FIG. 7 is a flowchart of processing procedure for a sound-signal generating process according to the present embodiment. The positional-relationship detecting unit 31b of the cell phone 10 extracts from the auto-focusing unit 29 information relating to the angle between the front direction of the cell phone 10 and the direction of the user, obtained from the angle of the auto-focusing unit 29 when it changes its orientation to the direction of the user (step S101).

The auto-focusing unit 29 executes an auto-focus processing to focus on the user (step S102), and determines whether the focus has been taken (step S103).

If the focus is not achieved (step S103: No), the processing shifts to step S102, where the auto-focus processing continues. When the focus is achieved (step S103: Yes), the positional-relationship detecting unit 31b extracts the information relating to the positional relationship between the user and the cell phone 10 obtained from the distance between the lens and the focal plane (step S104).

The sound-signal generating unit 31c then reads the head-related transfer function data 30d from the storing unit 30 (step S105), and sets the sound field/sound pressure that makes the user perceive a sound source in a predetermined position based on the angle and distance obtained from the positiohal-relationship detecting unit 31b (step S106).

The sound-signal generating unit 31c displays the set sound field/sound pressure on the LCD 26 as shown in FIG. 6 (step S107), and generates an audible sound signal to be output from the speaker 25 (step S108).

The sound-signal output unit 31d outputs the audible sound signal generated by the sound-signal generating unit 31c from the speaker 25 (step S109), and the sound-signal generating process ends.

Although the auto-focusing unit 29 detects the positional relationship between the cell phone 10 and the user, the auto-focusing unit 29 can also acceptably receive in advance from the user a set range for detecting his position, and detect his position only within this preset range.

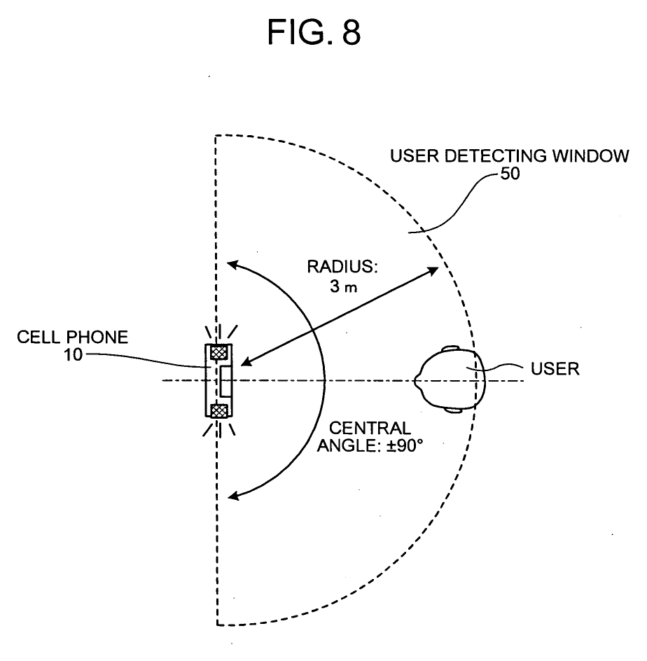

FIG. 8 is a schematic for illustrating a user detecting window 50 that limits a detection range of the user. In this case, the positional-relationship detecting unit 31b receives in advance from the user a setting relating to the radius and central angle that determine the size of the user detecting window 50.

The auto-focusing unit 29 detects the positional relationship between the cell phone 10 and the user only within the user detecting window 50, and, when it cannot detect the position of the user in the user detecting window 50, notifies the user by outputting a warning message to the LCD 26.

Alternatively, a time limit for detecting the positional relationship between the cell phone 10 and the user can be set in advance, the detection of the positional relationship being terminated if the positional-relationship detecting unit 31b cannot complete the detection within the time limit.

When the positional-relationship detecting unit 31b cannot detect the user's position in the user detecting window 50 and determines that his position is outside the user detecting window 50, to avoid an excessive sound pressure level, the sound-signal generating unit 31c can generate the sound signal such that its sound pressure level does not exceed the sound pressure level when the user's position is within the range of the user detecting window 50.

Although the auto-focusing unit 29 detects the positional relationship between the cell phone 10 and the user by taking the focus according to the present embodiment, an alternative is to store an image of the user's face in advance in the storing unit 30. The positional-relationship detecting unit 31b detects the positional relationship between the cell phone 10 and the user by cross-checking an image of the user's face taken by the imaging device 28 with the image of the user's face stored in the storing unit 30.

The positional-relationship detecting unit 31b detects the angle between the front direction of the cell phone 10 and the direction of the user by determining the position of the face image stored in the storing unit 30 in the image taken by the imaging device 28, and detects the distance between the cell phone 10 and the user by comparing the size of the face image stored in the storing unit 30 with that of the face image taken by the imaging device 28.

A plurality of auto-focusing units 29 that take the focus at predetermined distances and angles can be provided. Each auto-focusing unit 29 takes the focus with respect to the user, and the positional-relationship detecting unit 31b detects the positional relationship between the cell phone 10 and the user based on the focus taken by the auto-focusing unit 29 that is able to take the focus.

In this case, since the auto-focusing units 29 share the task of taking the focus with respect to the user within the range of distances and angles, it is not necessary for one auto-focusing unit 29 to take all the focuses in the range, enabling the positional relationship to be detected rapidly and efficiently.

Although the distance between the cell phone 10 and the user is detected by using the auto-focus function of the auto-focusing unit 29 according to the present embodiment, an alternative is to provide a plurality of fixed-focus imaging devices to the cell phone 10 and determine which imaging device takes a focused image of the user. The distance between the cell phone 10 and the user could then be determined from the focal distance of the fixed-focus imaging device.

Although the positional relationship between the cell phone 10 and the user is detected by taking the focus of the user according to the present embodiment, it is also possible to provide an ultrasonic irradiation unit that irradiates ultrasonic waves to the user. The positional-relationship detecting unit 31b detects the distance based on the time that the reflected waves take to arrive. Furthermore, the angle between the front direction of the cell phone 10 and the direction of the user can be detected from the irradiation angle of the ultrasonic waves.

Instead of ultrasonic waves, a backlight can be installed in the LCD 26 to brightly illuminate the screen of the LCD 26. The light from this backlight is irradiated to the user, and the distance is detected from the time that the reflected light takes to arrive. The angle between the front direction of the cell phone 10 and the direction of the user can be detected from the irradiation angle of the light from the backlight. It is assumed here that the orientation of the LCD 26 can be changed to enable the light from the backlight to be irradiated in a predetermined direction.

Another alternative is that infrared light from the infrared-communicating unit 22 is irradiated to the user, and the distance is detected from the time that the reflected light takes to arrive. The angle between the front direction of the cell phone 10 and the direction of the user can be detected from the irradiation angle of the infrared light. It is assumed here that the orientation of an infrared irradiation unit of the infrared-communicating unit 22 can be changed to enable the infrared light to be irradiated in a predetermined direction.

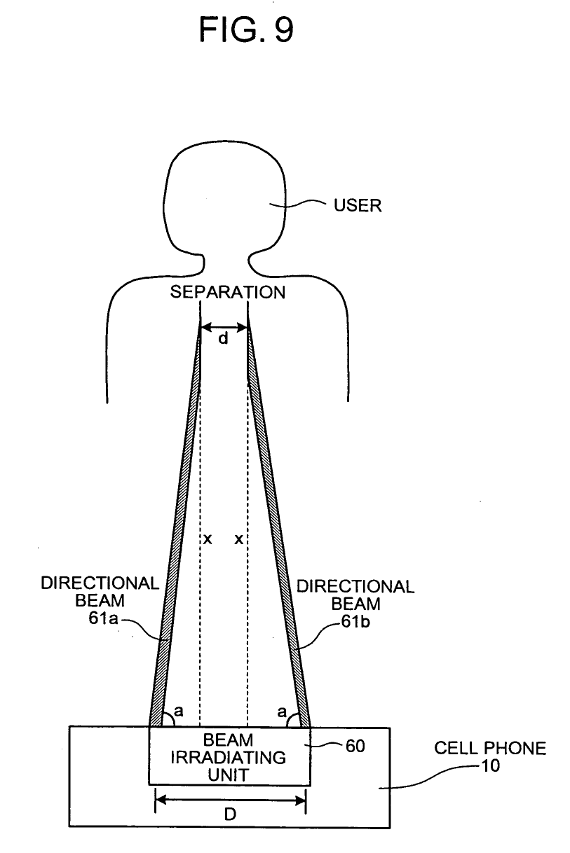

Yet another alternative is to detect the positional relationship between the cell phone 10 and the user by irradiating at least two directional beams at the user. FIG. 9 is a schematic for illustrating a process to detect a positional relationship between the cell phone 10 and the user by irradiating two directional beams.

A beam irradiating unit 60 is mounted on the cell phone 10, and irradiates two directional beams 61a and 61b at the user. The two directional beams 61a and 61b are irradiated inwardly at an angle “a” so that they intersect at a predetermined distance. The positional-relationship detecting unit 31b controls the imaging device 28 to take an image of the two directional beams 61a and 61b after they are reflected from the user.

The positional-relationship detecting unit 31b then determines the distance x between the cell phone 10 and the user from a separation d between the two reflected beams in the image that is taken, an irradiation separation D between the two directional beams 61a and 61b in the beam irradiating unit 60, and the irradiation angle “a”, using an equation expressed as
X=(D/2−d/2)·tan(a)

The cell phone 10 can include two distance measuring units that measure the distance between the cell phone 10 and the user by measuring the time taken for the reflected light to arrive after the beams are irradiated to the user. The positional relationship between the cell phone 10 and the user can be detected from the distances measured by these two distance measuring units.

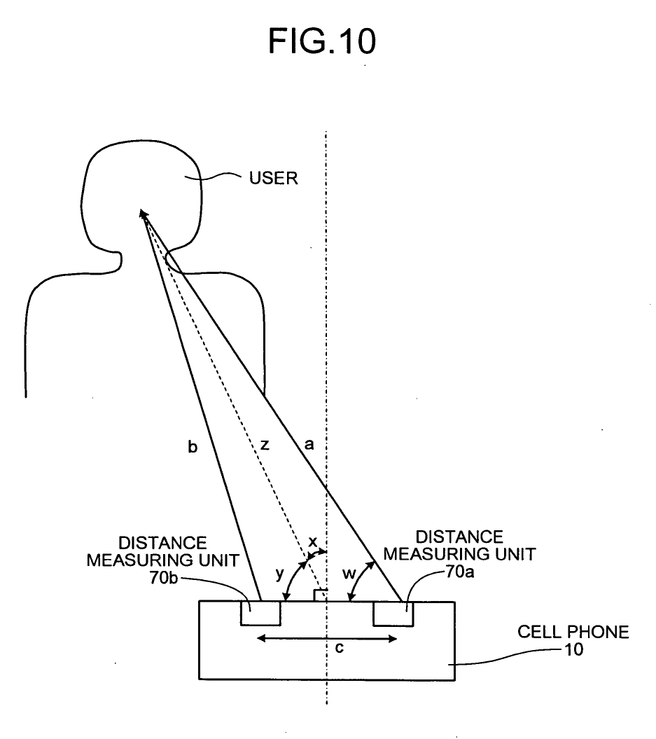

FIG. 10 is a schematic for illustrating a process to detect the positional relationship between the cell phone 10 and the user from distances measured by two distance measuring units 70a, 70b.

Here, a and b represent the distances to the user measured by the distance measuring units 70a and 70b that are fitted at different positions on the cell phone 10, c represents the interval between the installation positions of the distance measuring units 70a and 70b, z represents the distance between the cell phone 10 and the user, w represents the angle between the direction of the light irradiated by the distance measuring unit 70a and the front face of the cell phone 10, y represents the angle between the direction of the user at an intermediate point between the distance measuring units 70a and 70b and the front face of the cell phone 10, and x represents the angle between the front direction of the cell phone 10 and the direction of the user.

From the second cosine theorem, it can be deduced that the following relations are established between the parameters a, b, c, w, x, y, and z.
b²=a²+c²−2ac·cos(w)
z²=a²+(c/2)²−ac·cos(w)
b²=z²+(c/2)²−zc·cos(y)
x=90°−y

From these relations, the angle x between the front direction of the cell phone 10 and the direction of the user can be determined as
w=cos⁻¹ {(a²−b²+c²)/2ac},
z={(a²+b²−c²/2)/2}^{1/2},
y=cos⁻¹ {(a²−b²)/c/(2a²+2b²−c²)^{1/2}}, and
x=90°−cos⁻¹ {(a²−b²)/c/(2a²+2b²−c²)^{1/2}}.

When the auto-focusing unit 29 takes the focus by detecting contrast or detecting phase difference, the distance between the cell phone 10 and the user is determined by detecting an image of the user using a complementary metal-oxide semiconductor (CMOS) element, a charge-coupled device (CCD) element, or the like, and then taking the focus.

When using an element that captures a color image, such as a CMOS element and a CCD element, the auto-focusing unit 29 acquires a monochrome image by interposition of a red filter, a green filter, a blue filter, and so on, and then takes the focus, to improve a sensitivity.

When the focus is taken using an infrared method, the auto-focusing unit 29 detects the reflected light by using an Infrared Data Association (IrDA) element that transmits/receives infrared light, thereby taking the focus to determine the distance between the cell phone 10 and the user.

Since the infrared method enables the focus to be taken easily even in dark places, the positional-relationship detecting unit 31b can control the auto-focusing unit 29 such that, when the surrounding is brighter than a predetermined level, it takes the focus using visible light, and when the surround is darker than a predetermined level, it takes the focus using infrared light. The brightness of the surrounding is measured by an exposure controller that is fitted to the imaging device 28.

When the focus is taken by measuring the distance to the user using ultra wide band (UWB) electromagnetic waves, the auto-focusing unit 29 detects the reflected waves by using a UWB element that transmits/receives UWB waves, thereby taking the focus.

Although the multi-channel 3D surround system is realized by equipping the cell phone 10 with the plurality of speakers 25a to 25e according to the present embodiment, the sound signal can also be transmitted to another cell phone by close-range radio communication using the Bluetooth standard or the like, the sound signal being output from speakers fitted to the other cell phone.

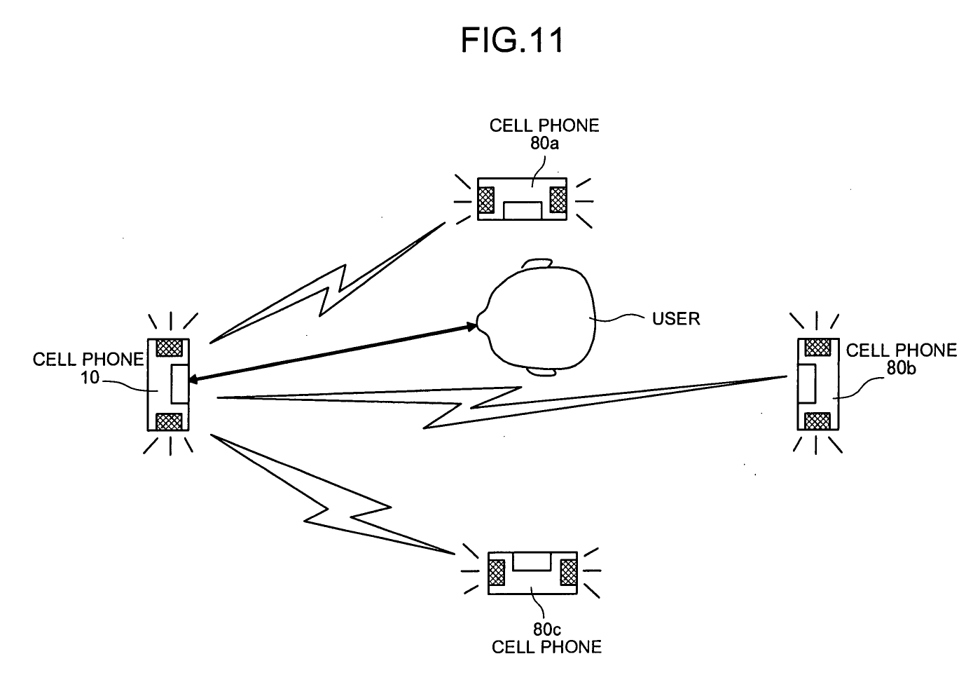

FIG. 11 is a schematic for illustrating a process to transmit a sound signal for 3D surround to other cell phones. In this case, a sound signal is generated by the sound-signal generating unit 31c of the cell phone 10 and transmitted by the close-range radio-communicating unit 23 to other cell phones 80a to 80c.

The sound signal that is transmitted to the other cell phones is a sound signal for 3D surround that is generated by the sound-signal generating unit 31c according to the location of each of the cell phones 80a to 80c, such as to make their users perceive sound sources at predetermined positions.

The sound-signal generating unit 31c obtains information relating to the locations of the cell phones 10, and 80a to 80c in advance. This location information can be input by the users, or obtained by detecting the positional relationship between the cell phone 10 and the other cell phones 80a to 80c by using a function for detecting the positional relationship between the cell phone 10 and the user such as those mentioned above.

The sound-signal generating unit 31c generates a sound signal for 3D surround to be'transmitted to each of the cell phones 80a to 80c, based on the information relating to the positional relationship between the cell phone 10 and the user and the information relating to the positional relationship between the cell phone 10 and the other cell phones 80a to 80c.

Although the auto-focusing unit 29 and the positional-relationship detecting unit 31b are fitted to the cell phone 10 according to the present embodiment, they can also be provided outside the cell phone 10 and connected to it via an external terminal that is fitted to the cell phone 10.

In this case, the sound-signal generating unit 31c of the cell phone 10 generates the sound signal by extracting information relating to the positional relationship between the cell phone 10 and the user from the positional-relationship detecting unit 31b that is installed outside the cell phone 10. Alternatively, the information relating to the positional relationship between the cell phone 10 and the user can be input by the user.

The various types of processing mentioned in the present embodiment can be implemented by making a computer execute a program prepared in advance. Accordingly, a computer that executes a program for implementing the processing described above will be explained below.

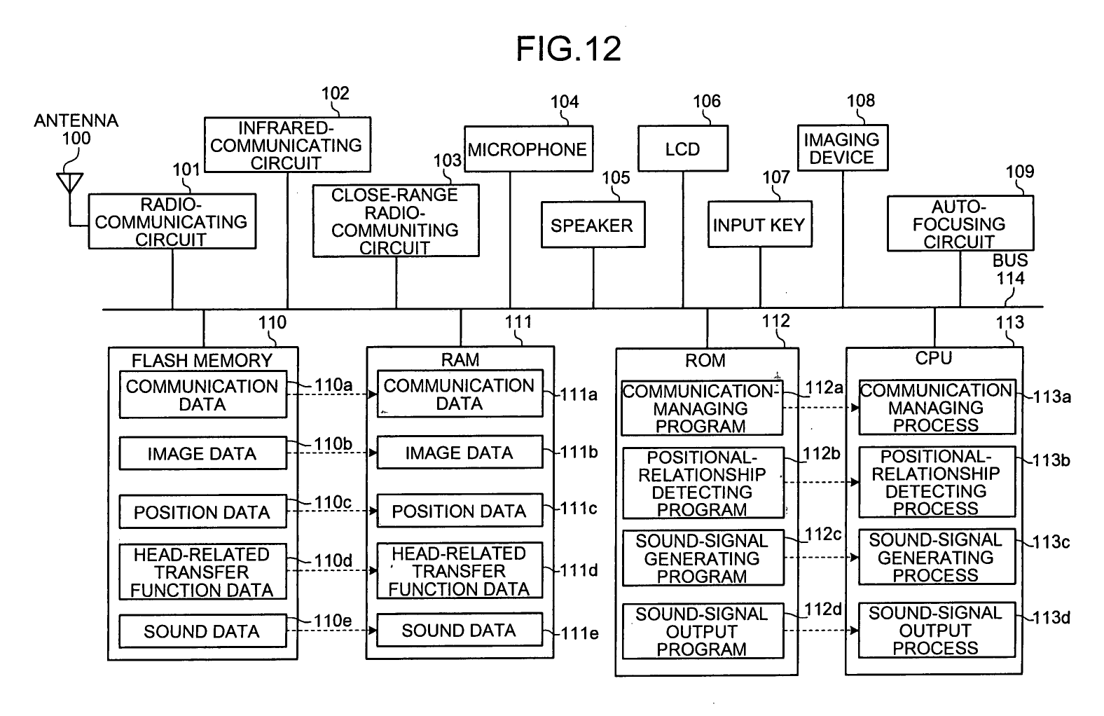

FIG. 12 is a block diagram of a hardware configuration of a computer that implements the cell phone 10 shown in FIG. 3. This computer includes an antenna 100, a radio-communicating circuit 101, an infrared-communicating circuit 102, a close-range radio-communicating circuit 103, a microphone 104, a speaker 105, an LCD 106, an input key 107, an imaging device 108, an auto-focusing circuit 109, a flash memory 110, a random access memory (RAM) 111, a read only memory (ROM) 112, a central processing unit (CPU) 113, connected via a bus 114.

The antenna 100, the radio-communicating circuit 101, the infrared-communicating circuit 102, the close-range radio-communicating circuit 103, the microphone 104, the speaker 105, the LCD 106, the input key 107, the imaging device 108, the auto-focusing circuit 109, and the flash memory 110, correspond respectively to the antenna 20, the radio communicating unit 21, the infrared-communicating unit 22, the close-range radio-communicating unit 23, the microphone 24, the speaker 25, the LCD 26, the input key 27, the imaging device 28, the auto-focusing unit 29, and the storing unit 30, shown in FIG. 3.

The ROM 112 stores programs that perform the same functions as the cell phone 10, namely, a communication management program 112a, a positional relationship detection program 112b, a sound signal generation program 112c, and a sound signal output program 112d. These programs can be stored in an integral or distributed manner as appropriate.

The CPU 113 implements the functions of a communication managing process 113a, a positional-relationship detecting process 113b, a sound-signal generating process 113c, and a sound-signal output process 113d, by reading the programs from the ROM 112 and executing them.

The communication managing process 113a, the positional-relationship detecting process 113b, a sound-signal generating process 113c, and a sound-signal output process 113d, respectively correspond to the communication managing unit 31a, the positional-relationship detecting unit 31b, the sound-signal generating unit 31c , and the sound-signal output unit 31d, shown in FIG. 3.

The flash memory 110 stores communication data 110an image data 110b, position data 110c, head-related transfer function data 110d, and sound data 110e.

The communication data 110a, the image data 110b, the position data 110c, the head-related transfer function data 110d, and the sound data 110e, respectively correspond to the communication data 30a, the image data 30b, the position data 30c, the head-related transfer function data 30d, and the sound data 30e, which are stored in the storing unit 30 shown in FIG. 3.

The CPU 113 stores these data in the flash memory 110, reads them from the flash memory 110 and stores them in the RAM 111, and executes various data processing based on communication data 111an image data 111b, position data 111c, head-related transfer function data 111d, and sound data 111e, stored in the RAM 111.

The communication management program 112a, the positional relationship detection program 112b, the sound signal generation program 112c, and the sound signal output program 112d, need not necessarily be stored in the ROM 112.

For example, the programs could be stored on a flexible disk (FD), a CD-ROM, a digital versatile disk (DVD), a magneto optical disk, an IC card, a hard disk drive (HDD), and “another computer (and server)” that is connected to the computer via a local area network (LAN), a wide area network (WAN), and the like; the computer reads the programs and executes them.

According to the present embodiment, when the positional relationship between the cell phone 10 and the user is detected, the sound-signal generating unit 31c of the cell phone 10 generates a sound signal that will make the user perceive a virtual sound source at a predetermined position in three-dimensional space based on the positional relationship that is detected. Therefore, even when the relative positions of the cell phone 10 and the user change, the effect of the 3D surround function fitted to the cell phone 10 can be realized adequately.

Furthermore, according to the present embodiment, a plurality of speakers is extended from the main unit of cell phone 10, and a cable leads the sound signal to each speaker. This enables the speakers to be arranged at positions that adequately realize the effect of the 3D surround function.

Moreover, according to the present embodiment, there are provided the left speaker 25a and the right speaker 25b that are extracted from the main unit of the cell phone 10. The positional-relationship detecting unit 31b adjusts the amount of extraction of the left speaker 25a and the right speaker 25b from the main unit of the cell phone 10 based on the detected positional relationship between the cell phone 10 and the user. This enables the speakers to be arranged at positions that adequately realize the effect of the 3D surround function.

Furthermore, according to the present embodiment, the sound-signal generating unit 31c generates a plurality of different sound signals to be reproduced in synchronism with each other, making it possible to realize a multi-channel 3D surround function that reproduces a fully realistic sound field.

Moreover, according to the present embodiment, a plurality of speakers output sound signals to be reproduced in synchronism with each other. The plurality of speakers include an LCD-panel speaker 25d that generates sound waves from the panel of the LCD 26, and the left speaker 25a and the right speaker 25b that are arranged on the left and right sides of the LCD-panel speaker 25d. Therefore, by using the LCD-panel speaker 25d, the cell phone 10 can independently realize a multi-channel 3D surround function and reproduce a fully realistic sound field.

Furthermore, according to the present embodiment, a plurality of speakers output sound signals to be reproduced in synchronism with each other. The plurality of speakers include at least a touch-panel speaker 25e that generates sound waves from a touch panel that the user inputs information to, and the left speaker 25a and the right speaker 25b provided on the left and right sides of the touch-panel speaker 25e. Therefore, by using the touch-panel speaker 25e, the cell phone 10 can independently realize a multi-channel 3D surround function and reproduce a fully realistic sound field.

Moreover, according to the present embodiment, the close-range radio-communicating unit 23 transmits the sound signals that are reproduced in synchronism to other cell phones by radio communication using the Bluetooth standard. Therefore, by using the other cell phones, it is possible to realize the multi-channel 3D surround function and reproduce a fully realistic sound field.

Furthermore, according to the present embodiment, the positional-relationship detecting unit 31b detects the positional relationship between its own cell phone and the user, and the sound-signal generating unit 31c generates a sound signal based on the detected positional relationship. Therefore, the cell phone 10 can detect the positional relationship without requiring another device.

Moreover, according to the present embodiment, the imaging device 28 takes an image of the user, and the positional-relationship detecting unit 31b detects the positional relationship by cross-checking the image of the user taken by the imaging device 28 with an image of the user stored in the storing unit 30 in advance. Therefore, the positional relationship can be efficiently detected by image cross-checking.

Furthermore, according to the present embodiment, a plurality of fixed-focus imaging devices having different focal distances take images of the user, and positional-relationship detecting unit 31b detects the positional relationship by determining which of the fixed-focus imaging devices has taken a well-focused image of the user. Therefore, the positional relationship can be efficiently detected by using imaging devices having different focal distances.

Moreover, according to the present embodiment, the auto-focusing unit 29 takes the focus of the user, and the positional-relationship detecting unit 31b detects the positional relationship based on the result of taking the focus. Therefore, the positional relationship can be efficiently detected by using the auto-focus function.

Furthermore, according to the present embodiment, a plurality of focusing units take the focus of the user within a predetermined range, and the positional relationship is detected based on the result obtained by the focusing units that have taken the focus successfully. Therefore, the positional relationship can be efficiently detected by taking the focus using the plurality of focusing units that take the focus in different ranges.

Moreover, according to the present embodiment, the distance measuring units 70a and 70b measure the distance to the user from a plurality of positions, and the positional-relationship detecting unit 31b detects the angle between the orientation of the cell phone 10 and the direction of the user based on the measured distances. Therefore, the angle between the orientation of the cell phone 10 and the direction of the user can be efficiently detected.

Furthermore, according to the present embodiment, an ultrasonic irradiation unit irradiates ultrasonic waves to the user, and the positional-relationship detecting unit 31b detects the positional relationship by detecting the ultrasonic waves that are reflected by the user. This enables the positional relationship to be efficiently detected by using ultrasonic waves.

Moreover, according to the present embodiment, a backlight illuminates the screen of the LCD 26 for displaying information, and the positional-relationship detecting unit 31b detects the positional relationship by detecting light that is reflected from the user after being generated by the backlight. This enables the positional relationship to be efficiently detected by using the backlight.

Furthermore, according to the present embodiment, the beam irradiating unit 60 irradiates two nonparallel directional beams 61a and 61b at the user, and the positional-relationship detecting unit 31b detects the interval between two beams formed when the directional beams 61a and 61b are reflected from the user, and determines the positional relationship based on this interval. Therefore, the positional relationship can be efficiently detected by using at least two nonparallel directional beams 61a and 61b.

Moreover, according to the present embodiment, the imaging device 28 takes a monochrome image of the user, and the positional-relationship detecting unit 31b detects the positional relationship based on the monochrome image that is taken. This increases the sensitivity when detecting the user, and enables the positional relationship to be efficiently detected.

Furthermore, according to the present embodiment, the auto-focusing unit 29 takes the focus by detecting visible light that is reflected by the user, and an infrared-detection focusing unit takes the focus by detecting infrared light that is reflected by the user. The positional-relationship detecting unit 31b selects whether to detect the positional relationship based on the focus taken by the auto-focusing unit 29 or detect the positional relationship based on the focus taken by the infrared-detection focusing unit according to the surrounding brightness, and detects the positional relationship based on the result of this selection. This enables the method for taking the focus to be selected as appropriate according to the surrounding brightness, and enables the positional relationship to be efficiently detected.

Moreover, according to the present embodiment, a range for detecting the positional relationship between the cell phone 10 and the user is set in the positional-relationship detecting unit 31b, and the positional-relationship detecting unit 31b detects the positional relationship within the set range. Therefore, the positional relationship can be detected within a range that is appropriate for generating sound signals.

Furthermore, according to the present embodiment, when the positional relationship between the cell phone 10 and the user is outside the detection range for detecting it, the sound-signal generating unit 31c generates a sound signal having an output level that does not exceed that of a sound signal within the detection range. This prevents the output level from becoming needlessly large when the cell phone 10 and the user are far apart.

Moreover, according to the present embodiment, a detection time for detecting the positional relationship between the cell phone 10 and the user is set in the positional-relationship detecting unit 31b, and detection of the positional relationship is terminated if the positional-relationship detecting unit 31b does not complete the detection within the set time. Therefore, by terminating the detection processing when it is difficult, battery consumption can be reduced.

Furthermore, according to the present embodiment, the positional relationship is defined by the distance between the cell phone 10 and the user. Therefore, by detecting the distance between the cell phone 10 and the user, even when this distance changes, the effect of the 3D surround function fitted to the cell phone 10 can be adequately realized.

Moreover, according to the present embodiment, the positional relationship is defined by the distance between the cell phone 10 and the user, and by the angle between the orientation of the cell phone 10 and the direction of the user. Therefore, even when the distance between the cell phone 10 and the user, and the angle between the orientation of the cell phone 10 and the direction of the user, change, the effect of the 3D surround function fitted to the cell phone 10 can be adequately realized.

While the embodiments of the present invention have been explained above, variously modified embodiments other than the explained ones can be made without departing from the scope of the technical spirit of the appended claims.

For example, although the information processing apparatus that generates the sound signals is the cell phone 10 according to the present embodiment, the present invention is not limited to this, and can be applied in a portable information processing apparatus such as a personal digital assistant (PDA), a personal computer, or a stationary sound system, and so on.

Of the respective process explained in the embodiments, all or a part of the process explained as being performed automatically can be performed manually, or all or a part of the process explained as being performed manually can be performed automatically in a known method.

The information including the process procedure, the control procedure, specific names, and various kinds of data and parameters shown in the specification or in the drawings can be optionally changed, unless otherwise specified.

The respective constituents of the cell phone 10 shown in the drawings are functionally conceptual, and physically the same configuration is not always necessary. In other words, the specific mode of dispersion and integration of each constituent element is not limited to the shown one, and all or a part thereof can be functionally or physically dispersed or integrated in an optional unit, according to the various kinds of load and the status of use.

All or an optional part of the various process functions performed by the cell phone 10 can be realized by the CPU or a program analyzed and executed by the CPU, or can be realized as hardware by the wired logic.

According to the present invention, the effect of the 3D surround function of an information processing apparatus can be adequately realized even when the relative positions of the information processing apparatus and a user change.

Furthermore, according to the present invention, a plurality of speakers can be arranged at positions that adequately realize the effect of the 3D surround function.

Moreover, according to the present invention, the speakers can be arranged at positions that adequately realize the effect of the 3D surround function.

Furthermore, according to the present invention, the 3D surround function can be realized with multiple channels and a fully realistic sound field can be reproduced.

Moreover, according to the present invention, by using liquid crystal display panel speakers, the information processing apparatus can independently realize the 3D surround function with multiple channels, and can reproduce a fully realistic sound field.

Furthermore, according to the present invention, by using touch-panel speakers, the information processing apparatus can independently realize the 3D surround function with multiple channels, and can reproduce a fully realistic sound field.

Moreover, according to the present invention, by using other devices, the 3D surround function can be realized with multiple channels and a fully realistic sound field can be reproduced.

Furthermore, according to the present invention, the information processing apparatus can detect the positional relationship without requiring other devices.

Moreover, according to the present invention, the positional relationship can be efficiently detected by image cross-checking.

Furthermore, according to the present invention, the positional relationship can be efficiently detected by using imaging units having different focal distances.

Moreover, according to the present invention, the positional relationship can be efficiently detected by using the auto-focus function.

Furthermore, according to the present invention, the positional relationship can be efficiently detected by taking the focus using a plurality of focusing units that take the focus in different ranges.

Moreover, according to the present invention, the angle between the orientation of the apparatus itself and the user can be efficiently detected.

Furthermore, according to the present invention, the positional relationship can be efficiently detected by using ultrasonic waves.

Moreover, according to the present invention, the positional relationship can be efficiently detected by using a backlight or the like.

Furthermore, according to the present invention, the positional relationship can be efficiently detected by irradiating at least two nonparallel directional beams at the user.

Moreover, according to the present invention, the sensitivity when detecting the user can be increased and the positional relationship can be efficiently detected.

Furthermore, according to the present invention, the method for taking the focus can be selected according to the surrounding brightness, and the positional relationship can be efficiently detected.

Moreover, according to the present invention, the positional relationship can be efficiently detected within a range that is appropriate for generating sound signals.

Furthermore, according to the present invention, the output level can be prevented from becoming needlessly large when the apparatus itself and the user are far apart.

Moreover, according to the present invention, battery consumption can be reduced by terminating detection processing of the positional relationship when, for example, it is difficult to detect.

Furthermore, according to the present invention, the effect of the 3D surround function fitted to the information processing apparatus can be adequately realized even when the distance between the information processing apparatus and the user changes.

Moreover, according to the present invention, the effect of the 3D surround function fitted to the information processing apparatus can be adequately realized even when the distance between the information processing apparatus and the user, and the angle between the orientation of the apparatus itself and the direction of the user, change.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a sound-signal generating unit that generates, when a positional relationship between a local information processing apparatus and a user is acquired, a sound signal that makes the user perceive a virtual sound source at a predetermined position in a three-dimensional space based on the acquired positional relationship.

2. The information processing apparatus according to claim 1, further comprising:
a plurality of speakers that is extended from a main body of the local information processing apparatus; and
a cable through which the sound signal is transmitted to the speakers.

3. The information processing apparatus according to claim 1, further comprising:
a plurality of speakers that is extended from a main body of the local information processing apparatus; and
an extension adjusting unit that adjusts an amount of extending the speakers from the main unit based on the positional relationship.

4. The information processing apparatus according to claim 1, wherein
the sound-signal generating unit generates a plurality of different sound signals that is reproduced in synchronization with each other.

5. The information processing apparatus according to claim 4, further comprising:
a plurality of speakers that outputs each of the sound signals, wherein
the speakers include at least
a liquid-crystal-display-panel speaker that generates a sound wave from a panel of a liquid crystal display; and
a plurality of side speakers spatially arranged on both sides of the liquid-crystal-display-panel speaker.

6. The information processing apparatus according to claim 4, further comprising:
a plurality of speakers that outputs each of the sound signals, wherein
the speakers include at least
a touch-panel speaker that generates a sound wave from a touch panel that receives information input by the user and; and
a plurality of side speakers spatially arranged on both sides of the touch-panel speaker.

7. The information processing apparatus according to claim 4, further comprising:
a sound-signal transmitting unit that transmits each of the sound signals to other apparatus by radio communication.

8. The information processing apparatus according to claim 1, further comprising:
a positional-relationship detecting unit that detects the positional relationship, wherein
the sound-signal generating unit generates the sound signal based on the positional relationship detected by the positional-relationship detecting unit.

9. The information processing apparatus according to claim 8, further comprising:
an imaging unit that captures an image of an object; and
an image storing unit that stores an image of the user, wherein
the positional-relationship detecting unit detects the positional relationship by collating an image of the user captured by the imaging unit with the image of the user stored in the image storing unit.

10. The information processing apparatus according to claim 8, further comprising:
a plurality of imaging units having different focal distances, wherein
the positional-relationship detecting unit detects the positional relationship by determining, when each of the imaging units captures an image of the user, which of the imaging units achieved a focus on the user.

11. The information processing apparatus according to claim 8, further comprising:
a focusing unit that focuses on an object, wherein
the positional-relationship detecting unit detects the positional relationship based on a result of achieving a focus on the user by the focusing unit.

12. The information processing apparatus according to claim 8, further comprising:
a plurality of focusing units that focuses on an object within a predetermined range, wherein
the positional-relationship detecting unit detects the positional relationship based on a result of achieving a focus on the user by a focusing unit that achieved the focus successfully from among the focusing units.

13. The information processing apparatus according to claim 8, further comprising:
a distance measuring unit that measures a distance to the user from a plurality of positions, wherein
the positional-relationship detecting unit detects an angle formed by an orientation of the local information processing apparatus and a direction of the user, based on the distance measured by the distance measuring unit.

14. The information processing apparatus according to claim 8, further comprising:
an ultrasonic-wave irradiating unit that irradiates an ultrasonic wave to the user, wherein
the positional-relationship detecting unit detects the positional relationship by detecting a reflected ultrasonic-wave that is reflected at the user.

15. The information processing apparatus according to claim 8, further comprising:
a light source that illuminates a screen of a liquid crystal display that displays information, wherein
the positional-relationship detecting unit detects the positional relationship by detecting a reflected light generated by a reflection of a light from the light source at the user.

16. The information processing apparatus according to claim 8, further comprising:
a directional-beam irradiating unit that irradiates at least two nonparallel directional beams to the user, wherein
the positional-relationship detecting unit detects a separation of reflected directional beams that are reflected at the user, and detects the positional relationship based on the separation of the reflected directional beams.

17. The information processing apparatus according to claim 1, wherein
the positional relationship includes a distance between the local information processing apparatus and the user.

18. The information processing apparatus according to claim 17, wherein
the positional relationship further includes an angle formed by an orientation of the local information processing apparatus and a direction of the user.

19. An information processing method comprising:
acquiring a positional relationship between a local information processing apparatus and a user; and
generating a sound signal that makes the user perceive a virtual sound source at a predetermined position in a three-dimensional space based on the acquired positional relationship.

20. A computer-readable recording medium that stores a computer program wherein, the computer program causes a computer to execute:
acquiring a positional relationship between a local information processing apparatus and a user;
storing information on the positional relationship; and
generating a sound signal that makes the user perceive a virtual sound source at a predetermined position in a three-dimensional space based on the information stored at the storing.
